(19) United States
(12) Patent Application Publication
(10) Pub. No.: US 2024/0140071 A1
(43) Pub. Date: May 2, 2024

(54) RESIN-COATED METAL SHEET FOR CONTAINERS

(71) Applicant: JFE Steel Corporation, Tokyo (JP)

(72) Inventors: Junichi Kitagawa, Chiyoda-ku, Tokyo (JP); Tomonari Hiraguchi, Chiyoda-ku, Tokyo (JP); Yuya Kawai, Chiyoda-ku, Tokyo (JP); Yasuhide Yoshida, Chiyoda-ku, Tokyo (JP)

(73) Assignee: JFE Steel Corporation, Tokyo (JP)

(21) Appl. No.: 18/280,328

(22) PCT Filed: Mar. 23, 2022
(86) PCT No.: PCT/JP2022/013678

§ 371 Date: Sep. 5, 2023

(30) Foreign Application Priority Data
Mar. 26, 2021 (JP) 2021-052875

(51) Int. Cl. B32B 15/09

(52) U.S. Cl. CPC B32B 15/09; B32B 2307/514; B32B 2307/7376

(57) ABSTRACT

A resin-coated metal sheet for containers includes a metal sheet and oriented films coating both surfaces of the metal sheet and made of a polyester resin, wherein the polyester resin includes 92 mol % or more of an ethylene terephthalate unit, the full-width at half maximum of a C═O peak at 1725 cm⁻¹±5 cm⁻¹ is 20 cm⁻¹ or more and 25 cm⁻¹ or less in Raman spectroscopy in an orientation direction of the surfaces of the films after coating the metal sheet, and the ratio (I₁₇₂₅/I₁₆₁₅) of the C═O peak intensity at 1725 cm⁻¹±5 cm⁻¹ to the C═C peak intensity at 1615 cm⁻¹±5 cm⁻¹ is 0.50 or more and 0.70 or less in the Raman spectroscopy.

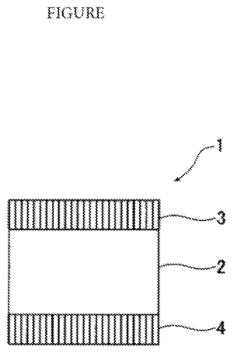

### CROSS REFERENCE TO RELATED APPLICATIONS

This is the U.S. National Phase application of PCT/JP2022/013678, filed Mar. 23, 2022 which claims priority to Japanese Patent Application No. 2021-052875, filed Mar. 26, 2021, the disclosures of these applications being incorporated herein by reference in their entireties for all purposes.

### FIELD OF THE INVENTION

The present invention relates to a resin-coated metal sheet for containers used for, for example, can bodies and lids for food cans, beverage cans, and aerosol cans.

### BACKGROUND OF THE INVENTION

In the related art, metal sheets such as tin free steel (TFS) sheets and aluminum sheets, which are food can materials, have a coating to improve corrosion resistance, durability, weather resistance, and other properties. However, the coating process has problems of not only complex baking but also a long processing time and discharge of a large amount of solvent.

To solve these problems, a film-laminated metal sheet produced by laminating a thermoplastic resin film on a heated metal sheet has been developed instead of a coated steel sheet and has been industrially used as a material for food cans, beverage cans, and aerosol cans.

In addition to basic properties, such as workability and adhesion, these materials require other properties associated with heat resistance and post-heat treatment workability because these materials undergo processing and other procedures after a print heat treatment, such as printing on can body outer surfaces or distortion printing. In a polyester resin-coated metal sheet known in the related art, the composition and the melting point range of the polyester resin has been controlled to improve heat resistance and post-heat treatment workability.

For example, in Patent Literature 1, a polyester film having a resin composition and a melting point in particular ranges is applied to a metal container. However, the dimensional change in heating in an atmosphere of 210° C. for 2 minutes is 2.0% or less, but in processing after printing heating such as distortion printing, film peeling or other defects occur after processing, and post-heat treatment workability is not adequate.

Patent Literature 2 discloses a film-laminated metal sheet including a polyester film. The thermal shrinkage of the polyester film at 130° C.×15 minutes is controlled in a particular range by blending a polybutylene terephthalate-based polyester and a polyethylene terephthalate-based polyester at a particular ratio. The film-laminated metal sheet is less subject to shrinkage wrinkling in drying after adhesive layer application and has good can formability, particularly, drawing formability and ironing formability. The film-laminated metal sheet also excels in heat lamination with metals and impact resistance and ensures preservation of taste and flavor. However, the presence of 40% or more and 80% or less by mass of the polybutylene terephthalate-based polyester having a melting point in the range of 200° C. or higher and 223° C. or lower causes the film crystallization to proceed in the heat treatment after printing and results in poor post-heat treatment workability.

Patent Literature 3 discloses a laminated metal sheet for two-piece cans including a first polyester resin layer formed on a surface which becomes the outer surface side after container formation, and a second polyester resin layer formed on a surface which becomes the inner surface side after container formation. The first polyester resin layer contains: 30 mass % or more and 60 mass % or less of polyethylene terephthalate or a copolymerized polyethylene terephthalate containing less than 6 mol % of a copolymer component; 40 mass % or more and 70 mass % or less of polybutylene terephthalate or a copolymerized polybutylene terephthalate containing less than 5 mol % of a copolymer component; and 0.01% or more and 3.0% or less of a polyolefin wax in outer percentage. The second polyester resin layer is made of a copolymerized polyethylene terephthalate containing less than 22 mol % of a copolymer component. The degree of residual orientation of the first and the second polyester resin layers is less than 30%. However, the presence of 40 mass % or more and 70 mass % or less of the polybutylene terephthalate component in the first polyester resin layer prevents or reduces retort blushing, but causes the film crystallization to proceed in the heat treatment, which results in poor post-heat treatment workability.

In Patent Literature 4, a biaxially oriented polyester film is used. The biaxially oriented polyester film is made from a copolyester containing a specific amount of a trivalent or higher valent carboxylic acid component in the acid components of the polyester film. It is disclosed that a polyester film for metal lamination that is suitable for heat lamination with metal sheets is produced by controlling the melting point and limiting viscosity of the polyester film in particular ranges. The polyester film also shows good higher-order workability in can forming after heat lamination, prevents or reduces hair formation at cut areas of heat-laminated metal sheets, and does not degrade the impact resistance of formed cans. Although hair formation is prevented or reduced, however, the polyester film has a melting point of 210° C. or higher and 235° C. or lower, which limits the heating temperature after printing and results in poor heat resistance.

### PATENT LITERATURE

Patent Literature 1: Japanese Unexamined Patent Application Publication No. 2006-289989
Patent Literature 2: Japanese Unexamined Patent Application Publication No. 2009-221315
Patent Literature 3: Japanese Unexamined Patent Application Publication No. 2014-166856
Patent Literature 4: Japanese Unexamined Patent Application Publication No. 2010-168432

### SUMMARY OF THE INVENTION

In light of such circumstances, aspects of the present invention are directed to a resin-coated metal sheet for containers in which the resin film has good basic properties required for food can materials, such as adhesion and coatability, as well as good post-heat treatment workability.

The inventors of the present invention have carried out intensive studies to solve the problem. As a result, it has been found that when an oriented film made of a polyester resin includes 92 mol % or more of an ethylene terephthalate unit, the full-width at half maximum of a C═O peak at 1725 cm⁻¹±5 cm⁻¹ is 20 cm⁻¹ or more and 25 cm⁻¹ or less in Raman spectroscopy in an orientation direction of the surface of the film after coating a metal sheet, and the ratio (I₁₇₂₅/I₁₆₁₅) of the C═O peak intensity at 1725 cm⁻¹±5 cm⁻¹ to the C═C peak intensity at 1615 cm⁻¹±5 cm⁻¹ is 0.50 or more and 0.70 or less, good post-heat treatment workability is obtained in addition to good basic properties, such as adhesion and coatability. The Raman spectroscopy at this time is performed on the film surface before a heat treatment.

When the difference in the full-width at half maximum of the Raman peak at 1725 cm⁻¹±5 cm⁻¹ in Raman spectroscopy on the surface of the polyester resin coating the metal sheet between the orientation direction and the directions 450 and 135° to the orientation direction after a heat treatment at 180° C.×10 minutes is 0.8 cm⁻¹ or more and 1.2 cm⁻¹ or less, it is possible to ensure advanced post-heat treatment workability.

Aspects of the present invention have been accomplished on the basis of the above findings, and are as follows.
[1] A resin-coated metal sheet for containers including a metal sheet and oriented films coating both surfaces of the metal sheet and made of a polyester resin, wherein the polyester resin includes 92 mol % or more of an ethylene terephthalate unit, a full-width at half maximum of a C═O peak at 1725 cm⁻¹±5 cm⁻¹ is 20 cm⁻¹ or more and 25 cm⁻¹ or less in Raman spectroscopy in an orientation direction of surfaces of the films after coating the metal sheet, and a ratio (I₁₇₂₅/I₁₆₁₅) of a C═O peak intensity at 1725 cm⁻¹±5 cm⁻¹ to a C═C peak intensity at 1615 cm⁻¹±5 cm⁻¹ is 0.50 or more and 0.70 or less in the Raman spectroscopy.
[2] The resin-coated metal sheet for containers according to [1], wherein a difference in full-width at half maximum of the C═O peak at 1725 cm⁻¹±5 cm⁻¹ in Raman spectroscopy on the surfaces of the films coating the metal sheet between the orientation direction and directions 450 and 135° to the orientation direction after a heat treatment at 180° C.×10 minutes is 0.8 cm⁻¹ or more and 1.2 cm⁻¹ or less.
[3] The resin-coated metal sheet for containers according to [1] or [2], wherein the film on an outer surface side of a container after a forming process contains 30 mass % or less of titanium oxide.
[4] The resin-coated metal sheet for containers according to [3], wherein the film on the outer surface side of the container after the forming process has at least two layers; when the film has two layers, the film includes an upper layer having a thickness of 1.0 μm or more and 5.0 μm or less and a lower layer having a thickness of 7 μm or more and 35 μm or less, and the lower layer faces the metal sheet, when the film has three or more layers, the film includes an outermost layer and a lowermost layer each having a thickness of 1.0 μm or more and 5.0 μm or less and a middle layer having a thickness of 6 μm or more and 30 μm or less, and the lowermost layer faces the metal sheet; the upper layer, the outermost layer, and the lowermost layer each contain 0 mass % or more and 2 mass % or less of titanium oxide, and the middle layer and the lower layer each contain 10 mass % or more and 30 mass % or less of titanium oxide.

Aspects of the present invention provide a resin-coated metal sheet for containers in which the resin film has good basic performances required for food can materials, such as adhesion and coatability, as well as good post-heat treatment workability.

### BRIEF DESCRIPTION OF DRAWINGS

The FIGURE is a schematic cross-sectional view of a resin-coated metal sheet for containers according to aspects of the present invention.

### DETAILED DESCRIPTION OF EMBODIMENTS OF THE INVENTION

Referring to the FIGURE, a resin-coated metal sheet for containers according to aspects of the present invention includes: a metal sheet 2; and films (resin coating layers 3 and 4) made of polyester resin and coating both surfaces of the metal sheet 2.

The resin-coated metal sheet for containers according to aspects of the present invention will be described below in detail. First, the metal sheet 2 used in accordance with aspects of the present invention will be described.

The metal sheet 2 according to aspects of the present invention may be, for example, an aluminum sheet or a mild steel sheet widely used as a can material. In particular, for example, a surface-treated steel sheet (hereinafter referred to as TFS) having a two-layer coating with a lower layer made of metal chromium and an upper layer made of chromium hydroxide is most suitable.

With regard to the coating weight of the TFS, the metal chromium layer is preferably 70 mg/m² or more and 200 mg/m² or less in terms of Cr, and the chromium hydroxide layer is preferably 10 mg/m² or more and 30 mg/m² or less in terms of Cr to improve adhesion after working and corrosion resistance.

Next, the films (resin coating layers 3 and 4) made of polyester resin on both surfaces of the resin-coated metal sheet for containers according to aspects of the present invention will be described. An oriented film is an uniaxially or biaxially oriented film, preferably a biaxially oriented film.

The films are made of polyester resin. The polyester resin layers contain polyethylene terephthalate as a main component and require heat resistance. The polyester resin thus includes 92 mol % or more of ethylene terephthalate units. Preferably, the polyester resin includes 93 mol % of ethylene terephthalate units.

Terephthalic acid used as an acid component is essential to ensure mechanical strength, heat resistance, corrosion resistance, and other properties. Terephthalic acid further improves workability, adhesion, and other properties when copolymerized with isophthalic acid. Copolymerization of 2 mol % or more and 10 mol % or less of the isophthalic acid component with the terephthalic acid component improves deep drawing formability and adhesion after working, which is preferred.

The terephthalic acid component may be copolymerized with other dicarboxylic acid components and glycol components unless the properties described above are impaired. Examples of dicarboxylic acid components include aromatic dicarboxylic acids, such as diphenylcarboxylic acid, 5-sodium sulfoisophthalic acid, and phthalic acid; aliphatic dicarboxylic acids, such as oxalic acid, succinic acid, adipic acid, sebacic acid, dimer acid, maleic acid, and fumaric acid; aliphatic dicarboxylic acids, such as cyclohexanedicarboxylic acid; and oxycarboxylic acids, such as p-oxybenzoic acid. Examples of other glycol components include aliphatic glycols, such as propanediol, butanediol, pentanediol, hexanediol, and neopentyl glycol; alicyclic glycols, such as cyclohexanedimethanol; aromatic glycols, such as bisphenol A and bisphenol S; and diethylene glycol and polyethylene glycol. These dicarboxylic acid components and glycol components may be used in combination of two or more. The terephthalic acid component may be copolymerized with polyfunctional compounds, such as trimellitic acid, trimesic acid, and trimethylolpropane as long as the advantageous effects according to aspects of the present invention are imparted.

The resin material is not limited by its production method. For example, there is a method in which terephthalic acid, ethylene glycol, and copolymer components are subjected to esterification reactions, and the resulting reaction product then undergoes polycondensation to produce a copolyester. Alternatively, the resin material can be formed by using, for example, a method in which dimethyl terephthalate, ethylene glycol, and copolymer components are subjected to transesterification reactions, and the resulting reaction product then undergoes polycondensation to produce a copolyester. In the production of a copolyester, additives, such as fluorescent whitening agents, antioxidants, heat stabilizers, UV absorbers, and antistatic agents may be added as needed. To improve whiteness, the addition of a fluorescent whitening agent is effective.

Importantly, the polyester resin layers that coat both surfaces of the resin-coated metal sheet for containers according to aspects of the present invention and that are mainly composed of polyethylene terephthalate have the following characteristics: the full-width at half maximum of the C═O peak at 1725 cm⁻¹±5 cm⁻¹ is in the range of 20 cm⁻¹ or more and 25 cm⁻¹ or less in Raman spectroscopy in the orientation direction of the surfaces of the films after coating the metal sheet; and the ratio (I₁₇₂₅/I₁₆₁₅) of the C═O peak intensity at 1725 cm⁻¹±5 cm⁻¹ to the C═C peak intensity at 1615 cm⁻¹±5 cm⁻¹ is in the range of 0.50 or more and 0.70 or less. These are the most important requirements in accordance with aspects of the present invention and make it possible to ensure adhesion, coatability, and post-heat treatment workability, which is an object according to aspects of the present invention. The phrase “the surfaces of the films after coating the metal sheet” means the surfaces of the films away from the metal sheet. The reason for this will be described below.

The full-width at half maximum of the C═O peak at 1725 cm⁻¹±5 cm⁻¹ determined by Raman spectroscopy is a measure of the crystallinity of the polyethylene terephthalate resin.

If the full-width at half maximum of the C═O peak at 1725 cm⁻¹±5 cm⁻¹ is less than 20 cm⁻¹, the crystallinity is high, and the molecular chains of polyethylene terephthalate are arranged relatively regularly. As a result, there is a tendency of high breaking strength but low flexibility and low elongation at break. If the full-width at half maximum of the C═O peak at 1725 cm⁻¹±5 cm⁻¹ is more than 25 cm⁻¹, the crystallinity is low, and the molecular chains of polyethylene terephthalate are arranged relatively randomly. As a result, there is a tendency of low breaking strength but high flexibility and high elongation at break. Therefore, the full-width at half maximum of the C═O peak at 1725 cm⁻¹±5 cm⁻¹ is 20 cm⁻¹ or more and 25 cm⁻¹ or less because the lower crystallinity is more advantageous to ensure workability, and the higher crystallinity is more advantageous to ensure corrosion resistance.

If the ratio (I₁₇₂₅/I₁₆₁₅) of the C═O peak intensity at 1725 cm⁻¹±5 cm⁻¹ to the C═C peak intensity at 1615 cm⁻¹±5 cm⁻¹ is less than 0.50, a high proportion of benzene rings and carbonyl groups derived from terephthalic acid is in random conformations. This results in weak interactions between molecular chains, so that the film tends to undergo cracking or other damages in response to the impact stress. If the ratio (I₁₇₂₅/I₁₆₁₅) is more than 0.70, a high proportion of benzene rings and carbonyl groups derived from terephthalic acid is arranged in the same plane, which results in dense molecular chains and low ductility. As a result, the film cannot adapt to deformation during working. Therefore, the ratio (I₁₇₂₅/I₁₆₁₅) is 0.50 or more and 0.70 or less.

In view of post-heat treatment workability, the structural change of the polyester film caused by heating is preferably uniform in every direction, with small anisotropy.

To improve post-heat treatment workability, the difference in the full-width at half maximum of the C═O peak at 1725 cm^{-1±5} cm⁻¹ in Raman spectroscopy on the surface of the polyester resin coating the metal sheet between the orientation direction and the directions 45° and 135° to the orientation direction after a heat treatment at 180° C.×10 minutes is preferably 0.8 cm⁻¹ or more and 1.2 cm⁻¹ or less. When the difference in the full-width at half maximum of the Raman peak is 1.2 cm⁻¹ or less, the film has better adhesion during working. More preferably, the difference in the full-width at half maximum of the Raman peak is 0.8 cm⁻¹ or more and 1.0 cm⁻¹ or less.

To enable forming with a high degree of working and ensure releasability from a die during forming or prevent being stuck during transport or other operations in a continuous forming line, a wax is preferably added to the resin coating layer on the outer surface side after container formation. Examples of waxes include, but are not limited to, olefin waxes, such as polyethylene, polypropylene, acid-modified polyethylene, and acid-modified polypropylene; fatty acid waxes, such as palmitic acid, stearic acid, sodium stearate, and calcium stearate; and natural waxes, such as carnauba wax. The resin coating layer on the outer surface side of the container after container formation preferably contains 0.10 mass % or more and 2.0 mass % or less of the wax component.

The intrinsic viscosity (IV) of the polyester resin coating layer on the container outer surface side or the container inner surface side after container formation is preferably 0.50 dl/g or more and 0.90 dl/g or less. The intrinsic viscosity (IV) of the polyester resin coating layer is more preferably 0.52 dl/g or more and 0.80 dl/g or less, still more preferably 0.55 dl/g or more and 0.75 dl/g or less. When the intrinsic viscosity of the resin coating layer is 0.50 dl/g or more, the molecular weight is high in the resin coating layer to ensure sufficient mechanical strength. When the intrinsic viscosity of the resin coating layer is 0.90 dl/g or less, good film formability is obtained. The intrinsic viscosity (IV) of the resin coating layer can be adjusted by controlling the polymerization conditions (e.g., the amount of polymerization catalyst, polymerization temperature, polymerization time), by using solid-phase polymerization in an inert atmosphere, such as nitrogen, or under vacuum after melt polymerization, or by other methods.

The polyester resin coating layer that will be the outer surface after container formation may be required to be white to improve design performance after forming or when printing. As long as the titanium oxide content relative to the weight of the entire resin coating layer is 30 mass % or less in this case, titanium oxide has no effect on workability and adhesion between the metal sheet and the resin coating layers in the forming process with a high degree of working. The titanium oxide content is preferably 8% or more to ensure enough whiteness even after working. Therefore, the lower limit of the titanium oxide content is preferably 8% or more, more preferably 10%, still more preferably 12% or more. The upper limit of the titanium oxide content is preferably 25% or less, more preferably 20% or less.

Titanium oxide can be added by using various methods as described below in (1) to (3). When titanium oxide is added by using the method (1), a slurry of titanium oxide dispersed in glycol is preferably added to the reaction system. The thickness of the resin coating layer 3 after addition of titanium oxide is preferably 10 μm or more to ensure whiteness after working. The lower limit of the thickness of the resin coating layer 3 is more preferably 12 μm or more, still more preferably 15 μm or more. As long as the resin layer containing titanium oxide has a thickness of 10 μm or more, the resin layer can resist tough working without cracking. The resin layer containing titanium oxide has a thickness of 40 μm or less from an economical viewpoint. The thickness of the resin layer is more preferably 35 μm or less, still more preferably 25 μm or less.

Method (1): titanium oxide is added before completion of transesterification or esterification reactions or before start of polycondensation in copolyester synthesis.
Method (2): titanium oxide is added to copolyester, and the mixture is melt-kneaded.
Method (3): master pellets containing a large amount of titanium oxide are produced in the method (1) or (2) and kneaded with a copolyester containing no particles to introduce a predetermined amount of titanium oxide.

The polyester resin coating layer that will be the inner surface or the outer surface after container formation may have a multilayer structure, and each layer may have its function. For example, the polyester resin coating layer may have a two-layer structure including an upper layer and a lower layer facing the metal sheet, or may have at least three layers including an outermost layer (upper layer), a middle layer (main layer), and a lowermost layer (lower layer) facing the metal sheet. In an example multilayer structure where each layer has its function, the total wax content in the resin coating layer is reduced by adding a wax to an outermost layer and/or a lowermost layer, whereby workability can be controlled effectively. In another example, a larger amount of pigment is added to a middle layer in a multilayer structure to control the color of the entire layer while ensuring workability and other properties. In these cases, the thickness of the outermost layer and the lowermost layer is 1.0 μm or more and 5.0 μm or less. The lower limit of the thickness of the outermost layer and the lowermost layer is preferably 1.5 μm or more, more preferably 2.0 μm or more. The upper limit of the thickness of the outermost layer and the lowermost layer is preferably 4.0 μm or less, more preferably 3.0 μm or less. The thickness of the middle layer is 6 μm or more and 30 μm or less. The lower limit of the thickness of the middle layer is preferably 8 μm or more, more preferably 10 μm or more. The upper limit of the thickness of the middle layer is preferably 25 μm or less, more preferably 20 μm or less. To obtain both whiteness and workability as a layer, the outermost layer and the lowermost layer contain 0 mass % or more and 2 mass % or less of titanium oxide, and the middle layer contains 10 mass % or more and 30 mass % or less of titanium oxide.

For the two-layer structure, the total wax content of the resin coating layer is reduced by adding a wax to the upper layer, whereby workability is controlled effectively. As in the three-layer structure, the thickness of the upper layer is 1.0 μm or more and 5.0 μm or less. The lower limit of the thickness of the upper layer is preferably 1.5 μm or more, more preferably 2.0 μm or more. The upper limit of the thickness of the upper layer is preferably 4.0 μm or less, more preferably 3.0 μm or less. The thickness of the lower layer is 7 μm or more and 35 μm or less. The lower limit of the thickness of the lower layer is preferably 9 μm or more, more preferably 11 μm or more. The upper limit of the thickness of the lower layer is preferably 30 μm or less, more preferably 25 μm or less. To obtain both whiteness and workability as a layer, the upper layer contains 0 mass % or more and 2 mass % or less of titanium oxide, and the lower layer contains 10 mass % or more and 30 mass % or less of titanium oxide.

In particular, addition of titanium oxide to the outermost layer improves adhesion between the resin coating layer and printing ink to improve printing quality. The titanium oxide content of the outermost layer is preferably 0.5 mass % or more to improve printing quality. As long as the titanium oxide content of the outermost layer is 2 mass % or less, the resin coating layer has better workability. The titanium oxide content of the outermost layer is therefore preferably 2 mass % or less.

To provide each layer of the three-layer structure with its function, the outermost layer and the lowermost layer perform their functions more effectively as long as the outermost layer and the lowermost layer each have a thickness of 1.0 μm or more, as described above. In other words, it is possible to effectively suppress breakage or abrasion of the resin coating layer and ensure enough luster on the surface of the polyester resin coating layer that will be the outer surface after container formation. To provide the outermost layer and the lowermost layer with their functions as described above, the outermost layer and the lowermost layer have a thickness of 5.0 μm or less from an economical viewpoint.

### [Production Method]

Next, a method for producing the resin-coated metal sheet for containers according to aspects of the present invention will be described. First, a method for producing the resin layers each having a multilayer structure and is coated on the metal sheet will be described.

The resin layers may be produced by any method. The following describes an example. Each polyester resin is dried as needed, then fed to a known fused deposition extruder, and extruded into a sheet through a slit die. Subsequently, the sheet is brought into close contact with a casting drum by application of electrostatic charges or other techniques, and cooled to a solid to provide a non-oriented sheet. This non-oriented sheet is stretched in the longitudinal direction and the transverse direction of the film to provide a biaxially oriented film. The stretching ratio can be set in accordance with the degree of orientation, the strength, the modulus of elasticity, and the like of a desired film. The film is preferably stretched by a tenter method in view of film quality. Preferred is a sequential biaxial stretching method in which stretching in the longitudinal direction is followed by stretching in the transverse direction, or a simultaneous biaxial stretching method in which stretching is carried out in the longitudinal direction and the transverse direction substantially simultaneously.

Next, a method for producing a resin-coated metal sheet by laminating resin layers (films) with a metal sheet will be described. Aspects of the present invention can use, for example, a method (hereinafter referred to as lamination) in which the metal sheet is heated to a temperature higher than or equal to the melting points of the films, and the resin films are brought into contact with and thermally fused to both surfaces of the metal sheet by using pressure rollers (hereinafter referred to as lamination rolls).

The lamination conditions are appropriately set so as to obtain the resin layers defined in accordance with aspects of the present invention. First, the surface temperature of the metal sheet at the beginning of lamination needs to be higher than or equal to the Tm (melting point) of the resin layers to be in contact with the metal sheet. Specifically, the surface temperature of the metal sheet needs to be controlled at Tm° C. or higher and (Tm+40°) C or lower. When the surface temperature of the metal sheet is higher than or equal to the Tm of the resin layers, the resin layers melt and wet the surface of the metal sheet to ensure good adhesion between the resin layers and the metal sheet. When the surface temperature of the metal sheet is higher than (Tm+40°) C, the resin layers may adhere to the lamination rolls, and it is difficult to control, within the scope of the present invention, the crystal structure of the resin layers in the surfaces of the films after coating the metal sheet. For this, a desired full-width at half maximum of the C═O peak at 1725 cm⁻¹±5 cm⁻¹ cannot be observed in Raman spectroscopy. The surface temperature of the metal sheet is preferably Tm° C. or higher and (Tm+25°) C or lower, more preferably Tm° C. or higher and (Tm+15°) C or lower.

In accordance with aspects of the present invention, the surface temperature of the lamination rolls needs to be adjusted to the Tg (glass transition temperature) of the resin layers or higher because the crystal structure of the resin layers in the surfaces of the films after coating the metal sheet needs to be controlled in an appropriate state. Specifically, the surface temperature of the lamination rolls to be in contact with the resin layers needs to be controlled at Tg° C. or higher and (Tg+80°) C or lower.

The adjustment of the contact time between the resin layers and the lamination rolls is also an important factor. The contact time needs to be controlled at 10 msec or longer and 20 msec or shorter. A desired crystal structure can be obtained by adjusting the surface temperature of the lamination rolls and the contact time to the above ranges.

When the surface temperature of the lamination rolls is lower than Tg° C. or the contact time between the resin layers and the lamination rolls is less than 10 msec, a high proportion of benzene rings and carbonyl groups derived from terephthalic acid is arranged in the same plane, and the ratio (I₁₇₂₅/I₁₆₁₅) is more than 0.70. When the surface temperature of the lamination rolls is higher than (Tg+80°) C or the contact time between the resin layers and the lamination rolls is more than 20 msec, a high proportion of benzene rings and carbonyl groups derived from terephthalic acid is in random conformations, and the ratio (I₁₇₂₅/I₁₆₁₅) is less than 0.50.

The resin layers are preferably heated before lamination. Softening the resin layers in advance can make more uniform the temperature distribution in the cross section of the resin layers at the time of lamination. This results in a gradual change in crystal structure in the cross section of the resin layers from the interface with the metal sheet to the surface layers and allows the resin layers to carry out more uniform performance. Specifically, the temperatures of the resin layers before lamination are preferably controlled at Tg° C. or higher and (Tg+30°) C or lower.

After completion of lamination, quenching (water cooling) needs to be performed immediately to fix the crystal structure of the resin layers. The time until quenching needs to be limited to 1 second or less, preferably 0.7 seconds or less. The temperature of quenching water needs to be the Tg of the resin layers or lower.

### EXAMPLES

Examples of the present invention will be described below.

### (Method for Producing Metal Sheet)

A steel sheet with a thickness of 0.22 mm and a width of 977 mm obtained after cold rolling, annealing, and temper rolling was subjected to degreasing, acid pickling, and subsequent chromium coating to produce a chromium-coated steel sheet (TFS). Chromium coating involved electroplating in a coating bath containing CrO₃, F⁻, and SO₄²⁻, intermediate rinsing, and subsequent electrolysis in a chemical conversion treatment liquid containing CrO₃ and F⁻. In the chemical conversion treatment, the electrolysis conditions (e.g., current density, quantity of electricity) were controlled such that the coating weight of metal chromium and the coating weight of chromium hydroxide were 120 mg/m² and 15 mg/m² in terms of Cr, respectively.

### (Method for Producing Resin Coating Films on Container Inner and Outer Surface Sides)

Polyester resins with the resin compositions shown in Table 1 were dried and melted in accordance with an ordinary method and coextruded from a T-die. The extruded material was then cooled to a solid on a cooling drum to provide a non-oriented film. The obtained non-oriented film was biaxially stretched and thermally set to provide a biaxially oriented polyester film.

TABLE 1

| | Resin Layer on Inner and Outer Surfaces | | | | | | | | | |
|---|---|---|---|---|---|---|---|---|---|---|
| | | | | Middle Layer (For 3 or More Layers) | | | | | | |
| | Outermost Layer | | | or Lower Layer (For Two Layers) | | | Lowermost Layer | | | TiO₂ |
| | | TiO₂ | thick- | | TiO₂ | thick- | | TiO₂ | thick- | wt % as |
| | composition | content | ness | composition | content | ness | composition | content | ness | Entire |
| | [mol %] | [wt %] | [μm] | [mol %] | [wt %] | [μm] | [mol %] | [wt %] | [μm] | Film |
| Example 1 | — | — | — | ethylene | 0 | 20 | — | — | — | 0 |
| | | | | terephthalate | | | | | | |
| | | | | 100 | | | | | | |
| Example 2 | — | — | — | ethylene | 0 | 20 | — | — | — | 0 |
| | | | | terephthalate 98 | | | | | | |
| | | | | ethylene | | | | | | |
| | | | | isophthalate 2 | | | | | | |
| Example 3 | — | — | — | ethylene | 0 | 20 | — | — | — | 0 |
| | | | | terephthalate 98 | | | | | | |
| | | | | ethylene | | | | | | |
| | | | | isophthalate 2 | | | | | | |
| Example 4 | — | — | — | ethylene | 0 | 20 | — | — | — | 0 |
| | | | | terephthalate 98 | | | | | | |
| | | | | ethylene | | | | | | |
| | | | | isophthalate 2 | | | | | | |
| Example 5 | — | — | — | ethylene | 0 | 20 | — | — | — | 0 |
| | | | | terephthalate 98 | | | | | | |
| | | | | ethylene | | | | | | |
| | | | | isophthalate 2 | | | | | | |
| Example 6 | — | — | — | ethylene | 0 | 20 | — | — | — | 0 |
| | | | | terephthalate 93 | | | | | | |
| | | | | ethylene | | | | | | |
| | | | | isophthalate 7 | | | | | | |
| Example 7 | — | — | — | ethylene | 0 | 20 | — | — | — | 0 |
| | | | | terephthalate 93 | | | | | | |
| | | | | ethylene | | | | | | |
| | | | | isophthalate 7 | | | | | | |
| Example 8 | ethylene | 0 | 2 | ethylene | 20 | 18 | — | — | — | 18 |
| | terephthalate 98 | | | terephthalate 98 | | | | | | |
| | ethylene | | | ethylene | | | | | | |
| | isophthalate 2 | | | isophthalate 2 | | | | | | |
| Example 9 | ethylene | 0 | 2 | ethylene | 20 | 16 | ethylene | 0 | 2 | 16 |
| | terephthalate 98 | | | terephthalate 98 | | | terephthalate 98 | | | |
| | ethylene | | | ethylene | | | ethylene | | | |
| | isophthalate 2 | | | isophthalate 2 | | | isophthalate 2 | | | |
| Comparative | — | — | — | ethylene | 0 | 20 | — | — | — | 0 |
| Example 1 | | | | terephthalate | | | | | | |
| | | | | 100 | | | | | | |
| Comparative | — | — | — | ethylene | 0 | 20 | — | — | — | 0 |
| Example 2 | | | | terephthalate 98 | | | | | | |
| | | | | ethylene | | | | | | |
| | | | | isophthalate | | | | | | |
| Comparative | — | — | — | ethylene | 0 | 20 | — | — | — | 0 |
| Example 3 | | | | terephthalate 98 | | | | | | |
| | | | | ethylene | | | | | | |
| | | | | isophthalate 2 | | | | | | |
| Comparative | — | — | — | ethylene | 0 | 20 | — | — | — | 0 |
| Example 4 | | | | terephthalate 90 | | | | | | |
| | | | | ethylene | | | | | | |
| | | | | isophthalate 10 | | | | | | |

| | Resin Layer on Inner and Outer Surfaces | | | | | | | | |
|---|---|---|---|---|---|---|---|---|---|
| | | | | | Full- | | Difference | | |
| | | | | | Width at | Peak | in Full- | Lamination Conditions | |
| | Total | | Glass | | Half | Intensity | Width at | | Lamination |
| | Thick- | Melting | Transition | | Maximum | Ratio | Half | Metal Sheet | Roll |
| | ness | Point | Temperature | | of C═O | I₁₇₂₅/I₁₆₁₅ | Maximum | Temperature | Temperature |
| | μm | [° C.] | [° C.] | Whiteness | [—] | [—] | of C═O | [° C.] | [° C.] |
| Example 1 | 20 | 255 | 80 | — | 20.0 | 0.65 | 1.1 | 268 | 120 |
| Example 2 | 20 | 250 | 79 | — | 21.0 | 0.65 | 1.2 | 262 | 100 |
| Example 3 | 20 | 250 | 79 | — | 25.0 | 0.52 | 0.8 | 260 | 100 |
| Example 4 | 20 | 250 | 79 | — | 25.0 | 0.50 | 0.8 | 267 | 120 |
| Example 5 | 20 | 250 | 79 | — | 21.0 | 0.70 | 1.1 | 258 | 80 |
| Example 6 | 20 | 235 | 76 | — | 22.0 | 0.62 | 0.9 | 246 | 80 |
| Example 7 | 20 | 235 | 76 | — | 24.0 | 0.60 | 0.5 | 246 | 80 |
| Example 8 | 20 | 250 | 78 | 80 | 23.0 | 0.61 | 0.7 | 265 | 80 |
| Example 9 | 20 | 250 | 78 | 76 | 23.0 | 0.61 | 0.7 | 265 | 80 |
| Comparative | 20 | 255 | 80 | — | 19.0 | 0.65 | 1.2 | 258 | 75 |
| Example 1 | | | | | | | | | |
| Comparative | 20 | 250 | 79 | — | 26.0 | 0.52 | 0.7 | 291 | 80 |
| Example 2 | | | | | | | | | |
| Comparative | 20 | 250 | 79 | — | 20.0 | 0.75 | 1.2 | 260 | 70 |
| Example 3 | | | | | | | | | |
| Comparative | 20 | 230 | 75 | — | 25.0 | 0.49 | 0.7 | 260 | 160 |
| Example 4 | | | | | | | | | |

### (Method for Producing Resin-Coated Metal Sheet for Containers)

The chromium-coated steel sheet produced above was laminated with polyester films. One surface was laminated with a polyester film (A), which will be on the container outer surface side after container formation, and the other surface was laminated with a polyester film (B), which will be on the container inner surface side. The FIGURE is a schematic view of a resin-coated steel sheet.

In the lamination of the metal sheet with the polyester film (A), the surface temperature of the metal sheet was controlled at Tm° C. or higher and (Tm+40) ° C. or lower of the polyester resin layer (al) constituting the polyester film (A). The surface temperature of a lamination roll (a) was Tg° C. or higher and (Tg+80) ° C. or lower of the polyester film (A). The surface temperature of a lamination roll (b) was (Tg+10) ° C. or higher and (Tg+110) ° C. or lower of the polyester film (B). The contact time between the polyester films and the metal sheet was 10 msec or more and 20 msec or less. The lamination rolls a and b were of an internal water cooling type. The temperature of the lamination rolls a and b during film lamination was controlled by circulating cooling water in the rolls. The temperatures of the resin layers before lamination were controlled at (Tg+30) ° C. or higher and (Tg+100) ° C. or lower of the polyester film (A) to make uniform the temperature distribution in the cross section of the resin layers. Subsequently, water cooling was performed in a metal-belt cooling device to produce a resin-coated metal sheet for containers.

### (Evaluation of Resin-Coated Metal Sheet for Containers)

The following properties of the resin-coated metal sheets produced above and the resin layers on the metal sheets were measured and evaluated. The measurement and evaluation methods are described below.

### (1) Evaluation of Crystallinity of Film Surface by Raman Spectroscopy

The full-width at half maximum of the Raman peak in the longitudinal direction (0°) and the transverse direction (90°) of the laminated steel sheets was determined by using flat sheet samples of laminated metal sheets before the heat treatment. In Examples, the longitudinal direction and the transverse direction correspond to the orientation directions of the films. From this measurement, the ratio of the C═O peak intensity at 1725 cm⁻¹±5 cm⁻¹ to the C═C peak intensity at 1615 cm⁻¹±5 cm⁻¹ was determined.

Next, a heat treatment at 180° C.×10 minutes was carried out. After the heat treatment, the full-width at half maximum of the Raman peak at 1725 cm⁻¹±5 cm⁻¹ in the longitudinal direction (0°) and the transverse direction (90°) of each flat sheet sample and at angles of 45° and 135° clockwise from the longitudinal direction was measured, and the difference in full-width at half maximum between each direction was obtained.

### (Measurement Conditions)

Measurement device: Raman Spectrometer Almega XR available from Thermo Fisher Scientific K.K.
Excitation light source: Semiconductor laser (λ=532 nm)
Microscope magnification: 100×

### Aperture: φ 25 μm

Measurement direction: the laser polarization plane is oriented parallel to the film longitudinal direction (0°), the transverse direction (90°), and the directions 45° and 135° clockwise from the longitudinal direction, with respect to the cross section of the laminated metal sheet.

### (2) Adhesion

The resin-coated metal sheet was cut into a size of 120 mm in the longitudinal direction and 30 mm in the transverse direction, which was used as a sample. A part of the film was peeled from the short side of the can inner surface of the sample. The peeled part of the film was opened in the direction (angle: 180°) opposite to the chromium-coated steel sheet from which the film had been peeled, and the peel test was performed at a cross head speed of 30 mm/min to evaluate the adhesion strength per 15 mm width.

### (Evaluation)

A: 11 N/15 mm or more
B: 8 N/15 mm or more and less than 11 N/15 mm
C: 5 N/15 mm or more and less than 8 N/15 mm
D: less than 2 N/15 mm
The resin-coated metal sheets rated B or higher were determined to have desired adhesion.

### (3) Coatability

The resin-coated metal sheet was coated with a wax and then punched out into a circular sheet having a diameter of 165 mm. The circular sheet was processed into a shallow drawn can at a drawing ratio of 1.52. Next, the shallow drawn can was drawn again at a drawing ratio of 1.60 to produce a drawn can. The conditions of the processed film of the drawn can were visually observed.

### (Evaluation)

A: no damage is observed in the film after forming.
B: forming is possible, but a damage (less than 3 mm) is observed in part of the film.
C: the can body breaks, and forming is impossible.
The resin-coated metal sheets rated B or higher were determined to have desired coatability.

### (4) Film Adhesion of Samples Formed After Heat Treatment

### (Post-Heat Treatment Workability)

The cans that were formable (B or higher) in the coatability evaluation (3) were tested for evaluation. The formed cans were subjected to the peel test at a cross head speed of 30 mm/min to evaluate the adhesion strength per 15 mm width. The evaluation target is the inner surface of the can body.

### (Evaluation)

A: 7 N/15 mm or more
B: 5 N/15 mm or more and less than 7 N/15 mm
C: 3 N/15 mm or more and less than 5 N/15 mm
D: 1 N/15 mm or more and less than 3 N/15 mm
E: less than 1 N/15 mm
The resin-coated metal sheets rated C or higher were determined to have desired post-heat treatment workability.

The evaluation results of adhesion, coatability, and post-heat treatment workability were summarized in Table 2.

TABLE 2

| | | | Post-Heat Treatment |
|---|---|---|---|
| | Adhesion | Coatability | Workability |
| Example 1 | B | B | B |
| Example 2 | B | B | C |
| Example 3 | A | A | B |
| Example 4 | A | A | A |
| Example 5 | B | B | C |
| Example 6 | B | A | B |
| Example 7 | B | A | A |
| Example 8 | B | A | C |
| Example 9 | B | A | B |
| Comparative | B | A | D |
| Example 1 | | | |
| Comparative | D | C | — |
| Example 2 | | | |
| Comparative | C | B | E |
| Example 3 | | | |
| Comparative | B | B | D |
| Example 4 | | | |

Invention Examples have good adhesion and coatability and further have good post-heat treatment workability. Comparative Examples outside the scope of the present invention are poor in at least one of adhesion, coatability, and post-heat treatment workability.

### INDUSTRIAL APPLICABILITY

The resin-coated metal sheet for containers according to aspects of the present invention is suitable for container applications and packaging applications needed for food can materials and aerosol can materials. The resin-coated metal sheet for containers according to aspects of the present invention can also be used as a can material to be processed by drawing or other process.

### REFERENCE SIGNS LIST

1 Resin-coated metal sheet for containers
2 Metal sheet
3, 4 Resin coating layer (film)

1. A resin-coated metal sheet for containers, the resin-coated metal sheet comprising a metal sheet and oriented films coating both surfaces of the metal sheet and made of a polyester resin,
wherein the polyester resin includes 92 mol % or more of an ethylene terephthalate unit,
a full-width at half maximum of a C═O peak at 1725 cm⁻¹±5 cm⁻¹ is 20 cm⁻¹ or more and 25 cm⁻¹ or less in Raman spectroscopy in an orientation direction of surfaces of the films after coating the metal sheet, and
a ratio (I₁₇₂₅/I₁₆₁₅) of a C═O peak intensity at 1725 cm⁻¹±5 cm⁻¹ to a C═C peak intensity at 1615 cm⁻¹±5 cm⁻¹ is 0.50 or more and 0.70 or less in the Raman spectroscopy.

2. The resin-coated metal sheet for containers according to claim 1, wherein a difference in full-width at half maximum of the C═O peak at 1725 cm⁻¹±5 cm⁻¹ in Raman spectroscopy on the surfaces of the films coating the metal sheet between the orientation direction and directions 45° and 135° to the orientation direction after a heat treatment at 180° C.×10 minutes is 0.8 cm⁻¹ or more and 1.2 cm⁻¹ or less.

3. The resin-coated metal sheet for containers according to claim 1, wherein the film on an outer surface side of a container after a forming process contains 30 mass % or less of titanium oxide.

4. The resin-coated metal sheet for containers according to claim 2, wherein the film on an outer surface side of a container after a forming process contains 30 mass % or less of titanium oxide.

5. The resin-coated metal sheet for containers according to claim 3,
wherein the film on the outer surface side of the container after the forming process has at least two layers;
when the film has two layers,
the film includes an upper layer having a thickness of 1.0 μm or more and 5.0 μm or less and a lower layer having a thickness of 7 μm or more and 35 μm or less, and the lower layer faces the metal sheet,
when the film has three or more layers,
the film includes an outermost layer and a lowermost layer each having a thickness of 1.0 μm or more and 5.0 μm or less and a middle layer having a thickness of 6 μm or more and 30 μm or less, and the lowermost layer faces the metal sheet;
the upper layer, the outermost layer, and the lowermost layer each contain 0 mass % or more and 2 mass % or less of titanium oxide, and
the middle layer and the lower layer each contain 10 mass % or more and 30 mass % or less of titanium oxide.

6. The resin-coated metal sheet for containers according to claim 4,
wherein the film on the outer surface side of the container after the forming process has at least two layers;
when the film has two layers,
the film includes an upper layer having a thickness of 1.0 μm or more and 5.0 μm or less and a lower layer having a thickness of 7 μm or more and 35 μm or less, and the lower layer faces the metal sheet,
when the film has three or more layers,
the film includes an outermost layer and a lowermost layer each having a thickness of 1.0 μm or more and 5.0 μm or less and a middle layer having a thickness of 6 μm or more and 30 μm or less, and the lowermost layer faces the metal sheet;
the upper layer, the outermost layer, and the lowermost layer each contain 0 mass % or more and 2 mass % or less of titanium oxide, and
the middle layer and the lower layer each contain 10 mass % or more and 30 mass % or less of titanium oxide.
